(19) United States
(12) Patent Application Publication
(10) Pub. No.: US 2018/0101875 A1
(43) Pub. Date: Apr. 12, 2018

(54) METHOD AND DEVICE FOR RECOMMENDING IN-STORE PRODUCT BY USING VISIBLE LIGHT COMMUNICATION

(71) Applicant: YUYANG DNU CO., LTD., Hwaseong-si, Gyeonggi-do (KR)

(72) Inventors: Sangok KIM, Seoul (KR); Byungoh KIM, Suwon-si (KR); Dongsik KIM, Hwaseong-si (KR)

(21) Appl. No.: 15/568,384

(22) PCT Filed: Jun. 16, 2015
(86) PCT No.: PCT/KR2015/006093

§ 371 Date: Oct. 20, 2017

(30) Foreign Application Priority Data
Apr. 21, 2015 (KR) 10-2015-0056162

(51) Int. Cl. G06Q 30/02; G06Q 30/06

(52) U.S. Cl. CPC G06Q 30/0282; G06Q 30/0631

(57) ABSTRACT

The present disclosure relates to an apparatus and method for recommending in-store products by using visible light communications which estimate whether a user needs to purchase a product based on product-related information received from a visible light illumination device installed in a store and the purchase history information of the user to provide the user with information related to the product as recommended product information for the user according to the result of estimation, thereby causing the user to refrain from purchasing unnecessary products and to more efficiently purchase products.

### TECHNICAL FIELD

The present disclosure relates to a method and apparatus for recommending in-store products using visible light communication.

### BACKGROUND

The statements in this section merely provide background information related to the present disclosure and do not necessarily constitute prior art.

In recent years, increasing demand by consumers to purchase more diverse products has gradually enlarged stores to the scale of department stores and hypermarkets where products are stocked and sold. Moreover, user requirements of the products are continuously increasing, and more diverse categories of products are exhibited and sold in the stores in order to satisfy such consumer requirements. While the large scale store allows consumers to browse and purchase a variety of products immediately, the diversification of products and increased shopping hours often divert the consumers' attention to unnecessary purchases from a planned shopping of just the goods that are supposed to be purchased.

Accordingly, there is a need for technology for allowing consumers in stores to be reminded of the targeted products that they actually need to purchase, thereby prompting the consumers to exercise restraint on unplanned purchases and enabling more efficient purchase of products.

### DISCLOSURE

### Technical Problem

Therefore, the present disclosure has been made in an effort to provide a product recommendation apparatus capable of estimating whether a user needs to purchase a product based on product-related information received from a visible light illumination device installed in a store and on the purchase history information of the user, and providing the user with information related to the product as recommended product information for the user according to the result of estimation, thereby causing the user to refrain from purchasing unnecessary products and to more efficiently purchase products.

### SUMMARY

In accordance with one aspect of the present disclosure, a product recommendation apparatus is provided for providing information on a product to a user in a store by using visible light communications. The product recommendation apparatus includes a communication unit, a storage unit and an analysis unit. The communication unit is configured to receive an optical signal from a visible light illumination apparatus installed in the store and to extract a product-related information included in the optical signal. The storage unit is configured to store a purchase history information of the user. The analysis unit is configured to perform an estimation of whether the user needs to purchase the product based on the product-related information and the purchase history information and to provide the product-related information as a recommended product information for the user according to a result of the estimation.

In another aspect of the present disclosure, a method of providing information on a product to a user in a store by a product recommendation apparatus using visible light communications, includes receiving an optical signal from a visible light illumination apparatus installed in the store and extracting a product-related information included in the optical signal, and performing an estimation of whether the user needs to purchase the product based on the product-related information and a pre-stored user's purchase history information and providing the product-related information as recommended product information for the user according to a result of the estimation.

### Advantageous Effects

According to some embodiments of the present disclosure, a product recommendation apparatus estimates whether a user needs to purchase a product based on the product-related information received from a visible light illumination apparatus installed in a store and the purchase history data about the user to provide the user with the product-related information as recommended product information for the user according to the result of estimation, thereby causing the user to refrain from purchasing unnecessary products and to more efficiently purchase products.

### BRIEF DESCRIPTION OF THE DRAWINGS

FIG. 1 is a schematic block diagram of a product recommendation system according to at least one embodiment of the present disclosure.

FIG. 2 is a schematic block diagram of a product recommendation apparatus according to at least one embodiment of the present disclosure.

FIG. 3 is a flowchart illustrating a method of recommending a product to be purchased to a user in a store using visible light communication by a product recommendation apparatus according to at least one embodiment of the present disclosure.

FIG. 4 is an exemplary diagram illustrating a method of providing recommended product information by a product recommendation apparatus according to at least one embodiment of the present disclosure.

FIG. 5 is an exemplary diagram illustrating embodiments of a product recommendation apparatus according to the present disclosure.

REFERENCE NUMERALS

| | |
|---|---|
| 100: Visible light illumination apparatus | |
| 110: Product recommendation apparatus | 120: Information provision |
| | apparatus |
| 130: Product payment apparatus | 210: Communication unit |
| 220: Display unit | 230: User interface unit |
| 240: Storage unit | 250: Analysis unit |
| 260: Output unit | 270: Collection unit |
| 280: Payment processing unit | |

### DETAILED DESCRIPTION

Hereinafter, the present disclosure will be described in detail with reference to the accompanying drawings.

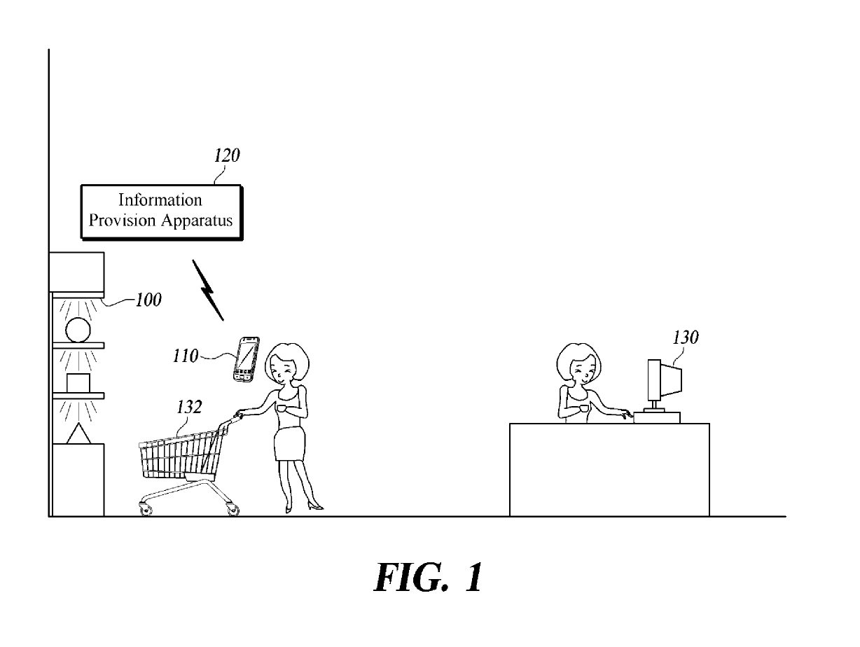

FIG. 1 is a block diagram schematically illustrating a product recommendation system according to at least one embodiment of the present disclosure. The product recommendation system according to at least one embodiment is implemented in a store such as a department store or a hypermarket and provides a product recommendation service that enables a user visiting the store to more efficiently make planned purchase of a necessary product for the user, using visible light communication. The product recommendation system according to at least one embodiment calculates the total purchase price information on the products that the user has determined to purchase, i.e., purchaser-decided products and provides the same information to the in-store product payment apparatus such that the purchaser-decided products can be purchased more quickly and conveniently.

The product recommendation system shown in FIG. 1 includes a visible light illumination apparatus 100, a product recommendation apparatus 110, an information provision apparatus 120, and a product payment apparatus 130. Here, the components included in the product recommendation system are not necessarily limited thereto. For example, in the product recommendation system, the visible light illumination apparatus 100 may be replaced with a tag information provision apparatus using RFID technology or the like, and is implemented with any apparatus as long as it transmits product-related information to the product recommendation apparatus 110.

The visible light illumination apparatus 100 uses light of a visible wavelength to carry and transmit information related to products displayed in a store to the product recommendation apparatus 110. In other words, when the product recommendation apparatus 110 is recognized within a visible light communication area, the visible light illumination apparatus 100 performs visible light communications to transmit an optical signal including the product related information to the product recommendation apparatus 110. The visible light illumination apparatus 100 is preferably implemented by a light emitting diode (LED), but is not limited thereto. The visible light illumination apparatus 100 is preferably disposed inside a display shelf on which products are displayed and transmits an optical signal including the product-related information of the displayed products to the product recommendation apparatus 110, but is not limited thereto.

Visible light communication is a technology using light from a lamp, such as an LED, which emits light by a semiconductor, as a communication light source. The light used in visible light communication is visible light having a wavelength of 380 nm to 780 nm and is capable of performing illumination and communication simultaneously, which is an advantage. Unlike a conventional communication method using various electromagnetic waves, visible light communications work by using the illumination light, which is harmless to the human body and requires no frequency license.

The visible light illumination apparatus 100 includes a product-related information input device (not shown) connected to the visible light illumination apparatus 100, in order to apply a signal including product-related information to the visible light illumination apparatus 100. That is, the product-related information input device may be arranged on a power supply line through which power for illumination is supplied to the visible light illumination apparatus 100, and may apply a signal including the product-related information to the power supplied to the visible light illumination apparatus 100. The product-related information input device is connected to an external server through a wired or wireless connection, and receives, from the external server, product-related information to be provided to the product recommendation apparatus 110, by using the visible light illumination apparatus 100.

The product-related information includes information such as the product category, name, price and discount. In this embodiment, the information included in the product-related information is not limited to specific information, and any information may be included as long as the information is related to the product. For example, in an embodiment, the product-related information may further include information such as position information, expiration date, and country of origin of a product corresponding to the installation coordinates of the visible light illumination apparatus 100.

The product recommendation apparatus 110 is an apparatus that provides a product recommendation service for a user in a store by utilizing visible light communication. The product recommendation apparatus 110 may be implemented in the form of any one of a tablet PC, a smartphone, a personal digital assistant (PDA), and a mobile communication terminal. The product recommendation apparatus 110 according to some embodiments determines and provides a recommended product for the user based on the product-related information received from the visible light illumination apparatus 100 installed in the store and on pre-stored user's purchase history information. To this end, the product recommendation apparatus 110 receives an optical signal from the visible light illumination apparatus 100 installed in the store, and extracts the product-related information from the optical signal. The product recommendation apparatus 110 pre-stores and provides the user's purchase history information. The product recommendation apparatus 110 stores the purchase history information of a user as follows. First, when the product recommendation apparatus 110 is implemented for personal use, it consistently collects purchase history information of the user and stores and manages the same in an internal memory. On the other hand, when implemented for public use, the product recommendation apparatus 110 receives, from the information provision apparatus 120, the purchase history information corresponding to a user currently carrying the product recommendation apparatus 110, and temporarily stores the same in the internal memory. The user's purchase history information includes purchased product information, the total number of purchases of the purchased product, the purchase dates of the purchased product, price information at the time of purchase of the purchased product, and discount information at the time of purchase of the purchased product. In the present disclosure, the purchase history information is not limited to include only specific information but it also includes any history information related to the purchase of the product. The product recommendation apparatus 110 may classify and store the user's purchase history information based on various criteria such as product name and purchase date.

Based on the product-related information received from the visible light illumination apparatus 100 and the pre-stored user's purchase history information, the product recommendation apparatus 110 estimates whether or not the user needs to purchase a product at the current position of the user, i.e., a product displayed at the installation point of the visible light illumination apparatus 100 that has transmitted the product-related information. Subsequently, when the estimation result from estimating the user's need to purchase the product determines that there is a need for the user to purchase that product, the product recommendation apparatus 110 determines the product as a recommended product, and provides the product-related information received from the visible light illumination apparatus 100 to the user as recommended product information.

The following will detail on the method of determining a recommended product for a user by the visible light illumination apparatus 100 based on the product-related information received from the visible light illumination apparatus 100 and the pre-stored user's purchase history information. Additionally, in the following description, a product corresponding to the product-related information received from the visible light illumination apparatus 100 will be referred to as a candidate product.

When the product recommendation apparatus 110 determines, based on the product-related information received from the visible light illumination apparatus 100 and the pre-stored user's purchase history information, that the user purchased the candidate product at least a predetermined number of times at the current point in time after at least a predetermined period elapsed since the candidate product was last purchased, the product recommendation apparatus 110 determines the candidate product as a recommended product for the user. Here, the predetermined period is based on the purchase history information of the candidate product, more specifically, on the average value of the purchase periods of the candidate product calculated based on the previous purchase dates of the candidate product. The product recommendation apparatus 110 calculates a point of time having passed by the average value of the purchase periods of the candidate product from the last purchase of the candidate product, as a repurchase time of the candidate product. If the difference between the current time and the calculated repurchase time of the candidate product is less than a predetermined threshold, the product recommendation apparatus 110 determines that there is a need for the user to purchase the candidate product.

According to some embodiments, when the product recommendation apparatus 110 determines that there is a persistent user demand for a candidate product and the time for repurchase of the candidate product has arrived based on the current point in time, the product recommendation apparatus 110 determines the candidate product as a recommended product. The user of the product recommendation apparatus 110 may receive a recommendation just on the products that the user actually needs to purchase. Thereby, the user may be caused to refrain from purchasing unnecessary products and to more efficiently purchase products.

In some embodiments, even if it is not after at least the predetermined period of time has elapsed since the last purchase of the candidate product, the product recommendation apparatus 110 may determine the candidate product as a recommended product if the user demand for the candidate product persists and the current price of the candidate product has decreased by at least a predetermined threshold value from the price when the user last purchased the candidate product. That is, product recommendation apparatus 110 according to the present disclosure presumes that there is a possibility that the user will repurchase the candidate product later if user demand for the candidate product is persistently present. Thus, even before the time to repurchase the candidate product, the product recommendation apparatus 110 determines the candidate product as a recommended product for the user when the current price of the candidate product is much lower than before. Accordingly, the user of the product recommendation apparatus 110 is allowed to more efficiently purchase a product that is persistently demanded.

According to some embodiments, even when the number of times of purchase of the candidate product is less than a predetermined number, the product recommendation apparatus 110 determines the candidate product as a recommended product for the user if the candidate product was purchased within a preset period before the current point in time. Here, the preset period may be set to various values depending on the kind of the candidate product and user selection. Even if the user's demand for the candidate product is not persistently present, the product recommendation apparatus 110 may determine that there is user interest in or preference to the candidate product and that the user is very likely to purchase the product if the candidate product is a product purchased within a preset period before the current point in time. The product recommendation apparatus 110 may determine the candidate product as a recommended product for the user irrespective of the number of times the user purchases the candidate product, reflecting the purchase propensity of the user. This enables the user of the product recommendation apparatus 110 to be provided with a more satisfactory product recommendation service.

The product recommendation apparatus 110 may store user information including information on the user's family members further to the user's purchase history information. Therefore, the product recommendation apparatus 110 according to some embodiments may additionally provide the user with the recommended purchase quantity information with respect to the recommended product as well as the product-related information on the recommended product. The product recommendation apparatus 110 according to some embodiments infers the degree of consumption of the previously purchased recommended product at the current point in time based on the number of family members, the purchase period of the recommended product, and the time between the last purchase of the recommended product and the current time, and additionally calculates and provides a recommended purchase quantity of the recommended product according to the result of inference. Thereby, the user of the product recommendation apparatus 110 can more efficiently purchase products which the user actually needs to purchase.

When the current price of the determined recommended product has increased from the product price at the last purchase of the recommended product by at least a predetermined threshold value, the product recommendation apparatus 110 may further provide the price change information and information on an alternative product to replace the recommended product. At this time, the product recommendation apparatus 110 in some embodiments provides a product in the same category as the recommended product as the alternative product among the products previously purchased by the user, based on the pre-stored user's purchase history information, but embodiments are not limited thereto. For example, the product recommendation apparatus 110 may be informed about an alternative product in the same category as the recommended product from the information provision apparatus 120, and it may provide the information to the user. When a plurality of alternative products is available, the product recommendation apparatus 110 may receive, from the information provision apparatus 120, information exclusively on an alternative product selected based on various criteria such as price range or user preference.

Upon receiving the user's purchase selection information of the recommended product from the user, the product recommendation apparatus 110 may receive additional discount information from the information provision apparatus 120 according to selection of purchase of the recommended product, and additionally provide the same to the user. The product recommendation apparatus 110 according to some embodiments not only provides information on the recommended product, but also provides an additional discount according to the selection of the recommended product, thereby satisfying both the user and the seller.

To ensure efficiency of the product recommendation service, upon receiving the user's purchase selection information of the recommended product, the product recommendation apparatus 110 does not determine another product in the same category as the recommended product as a recommended product. For example, upon recognizing the user's purchase selection information of a specific milk product provided as the recommended product, the product recommendation apparatus 110 does not determine other milk products as the recommended product.

The product recommendation apparatus 110 may selectively determine another product in the same category as that of the recommended product, as a recommended product. To this end, the product recommendation apparatus 110 according to some embodiments stores and provides additional user information including family member information and purchase history information of the family members. The product recommendation apparatus 110 may identify a product for which the user's family members have a high preference among other products in the same category as the recommended product previously selected by the user, based on the purchase history information of the family members, and determine the product as a recommended product. In this regard, the preference of the family members to a specific product is determined according to factors such as the number of purchases of the specific product and the dates of the purchases. The product recommendation apparatus 110 determines the recommended product further considering the user family member purchase history information. Thereby, the user may efficiently purchase products desired not only by the user but also by all the family members of the user.

The product recommendation apparatus 110 classifies the products included in the purchase history information of the family members into public products and private products according to kinds of the products, stores the same, and selectively provides only the purchase history information corresponding to the public products according to the classification result as a parameter for calculating a recommended product. For example, the product recommendation apparatus 110 may classify daily necessities among the products purchased by the family members into public products and classify products of personal preference such as cigarettes and liquor into private products. The user and the family members may have a choice of the classification criterion for classifying the public products and the private products. The product recommendation apparatus 110 according to some embodiments classifies purchase history information of the family members into public products and private products, and provides only purchase history information corresponding to the public products as a parameter for calculating a recommended product. Thereby, privacy protection can be maintained among the family members.

The product recommendation apparatus 110 calculates the total purchase price information of the products that the user has determined to purchase (i.e., purchaser-decided products) and provides the same information to the product payment apparatus 130 in the store, such that purchase can proceed quickly and conveniently.

Hereinafter, the method of calculating the total purchase price information of the purchaser-decided products and providing the information to the product payment apparatus 130 in the store by the product recommendation apparatus 110 will be described in more detail.

The product recommendation apparatus 110 collects product-related information of products loaded in a shopping cart 132 (i.e., products pending purchase). The product recommendation apparatus 110 collects product-related information of the products pending purchase and loaded in the shopping cart 132 by using a barcode scanner, a camera provided in the product recommendation apparatus 110, or the like. Here, the product-related information of the products pending purchase includes information such as the category, name, quantity, price and discount of the products pending purchase.

When the product recommendation apparatus 110 receives purchase confirmation information of at least one product pending purchase among those pending purchase from the user, the product recommendation apparatus 110 calculates the total purchase price information of the at least one product pending purchase based on the product-related information of the products pending purchase. Then, the product recommendation apparatus 110 provides the calculated total purchase price information to the product payment apparatus 130 in the store.

The information provision apparatus 120 transmits and receives data to and from the product recommendation apparatus 110 using wireless communication. The information provision apparatus 120 according to some embodiments collects and stores product purchase information of users, and thereafter, upon receiving a request for purchase history information of a specific user from the product recommendation apparatus 110, provides the recommendation apparatus 110 with purchase recommendation information corresponding to the specific user depending on whether or not the user is authenticated. The information provision apparatus 120 may collect further personal information including family relations of users, and store and provide classified product purchase information of each of the family members based on the collected personal information.

When the product recommendation apparatus 110 receives the user's purchase selection information of a product recommended for the user by the product recommendation apparatus 110 from the product recommendation apparatus 110, the information provision apparatus 120 provides additional discount information of the recommended product to the product recommendation apparatus 110. The additional discount information may be a discount coupon or the like.

Upon receiving an information request command for an alternative product for replacing a specific product from the product recommendation apparatus 110, the information provision apparatus 120 determiness an alternative product in the same category as the specific product by using the pre-stored information about all the products in the store, and provides the alternative product information to the product recommendation apparatus 110.

The product payment apparatus 130 refers to an apparatus that performs a payment procedure for the products that the user has decided to purchase. The product payment apparatus 130 according to some embodiments receives, from the product recommendation apparatus 110, the total purchase price information of the products which the user has decided to purchase and performs the payment procedure based on the received information. For example, the product payment apparatus 130 stores the total purchase price information received from the product recommendation apparatus 110 for each user, and then outputs total purchase price information corresponding to a specific user at the time when the specific user pays for the products, such that a quick and convenient purchase can be made for the purchaser-decided products. The product payment apparatus 130 may further receive payment method information together with the total purchase price information of the products which the user has decided to purchase from the product recommendation apparatus 110 and thereby perform the payment procedure in advance for the purchaser-decided products. The product payment apparatus 130 is preferably a point of sale (POS) terminal, but is not limited thereto.

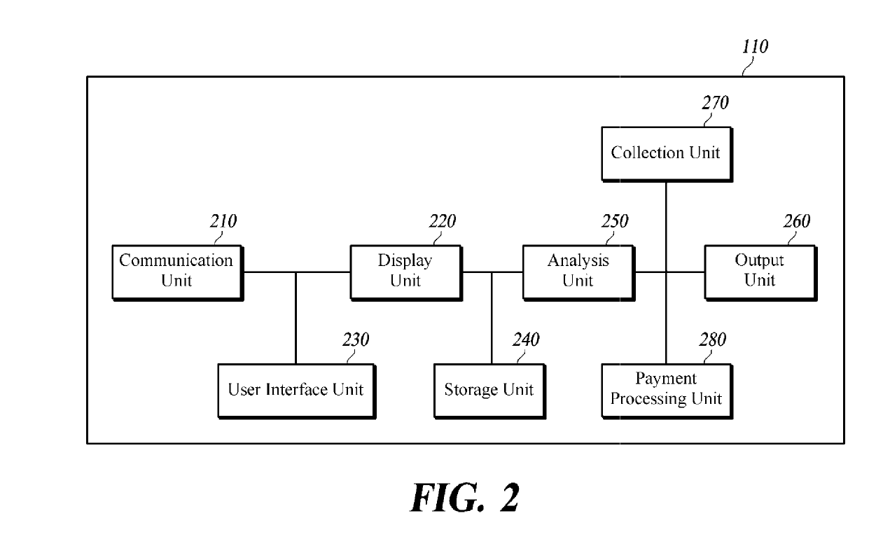

FIG. 2 is a block diagram schematically illustrating a product recommendation apparatus according to some embodiments.

As shown in FIG. 2, the product recommendation apparatus 110 according to some embodiments includes a communication unit 210, a display unit 220, a user interface unit 230, a storage unit 240, an analysis unit 250, an output unit 260, a collection unit 270, and a payment processing unit 280.

The communication unit 210 receives an optical signal from the visible light illumination apparatus 100 installed in the store, extracts product-related information included in the optical signal, and provides the extracted information. The communication unit 210 includes a means for sensing an optical signal, for example, an optical sensor, processes the product-related information included in the received optical signal into information that can be analyzed and recognized by using the optical sensor, and provides the processed information. The communication unit 210 further includes a wireless communication means capable of performing wireless communication with an external device, and utilizes the wireless communication means to wirelessly communicate with the information provision apparatus 120 and the product payment apparatus 130, thereby transmitting and receiving the necessary data for providing a product recommendation service and an expedited product payment service.

The display unit 220 outputs an information provision window for the recommended product determined using the analysis unit 250. Information such as a photograph, product name, category, manufacturer, price, and discount of the recommended product is provided in the information provision window for the recommended product. The information output through the display unit 220 is controlled by the output unit 260.

The display unit 220 outputs the product-related information of the products pending purchase that are collected by the collection unit 270 and the total purchase price information of the purchaser-decided products calculated by the payment processing unit 208.

The user interface unit 230 interworks with the display unit 220 and receives various kinds of selection information and input information from a user having the product recommendation apparatus 110. The user interface unit 230 may receive the selection information and the input information input by the user, using a touchscreen, a keypad, and a method such as voice recognition.

The storage unit 240 stores the purchase history information of the user. The storage unit 240 classifies and stores the purchase history information of the user according to various criteria such as a product name and a purchase date, and provides the stored purchase history information to the analysis unit 250. Then, the analysis unit 250 uses the user's purchase history information provided from the storage unit 240 as a parameter for calculating a recommended product for the user. The user's purchase history information may include the purchased product information, the total number of purchases of the purchased product, the purchase date of the purchased product, price information at the time of purchase of the purchased product, and discount information at the time of purchase of the purchased product. The user's purchase history information may be provided from the information provision apparatus 120.

The storage unit 240 according to some embodiments stores further user information including the user's family members and the purchase history information of the family members, and provides the stored user information to the analysis unit 250. Similarly, the analysis unit 250 uses the purchase history information of the family members provided from the storage unit 240 as a parameter for calculating a recommended product for the user. The storage unit 240 classifies the products included in the purchase history information of the family members into public products and private products by their categories, stores the same, and selectively provides only the purchase history information corresponding to the public products according to the classification result to the analysis unit 250 as a parameter for calculating a recommended product. The purchase history information of the family members is preferably provided from the information provision apparatus 120, but embodiments are not limited thereto.

The analysis unit 250 determines and provides a recommended product for a user in the store by using the product-related information received by the communication unit 210 and the purchase history information pre-stored in the storage unit 240.

Hereinafter, a method of calculating a recommended product for a user in a store by the analysis unit 250 based on the product-related information and the user's purchase history information will be described. The method of calculating a recommended product by the analysis unit 250 based on the product-related information and the user's purchase history information is the same as the method of calculating a recommended product by the product recommendation apparatus 110 based on the product-related information and the user's purchase history information disclosed above, and thus a detailed description thereof will be omitted.

The analysis unit 250 estimates whether or not the user needs to purchase a product located at the current position of the user, namely, a product displayed where the visible light illumination apparatus 100 is installed and has transmitted the product-related information (hereinafter referred to as a candidate product), on the basis of the product-related information and the user's purchase history information. Then, upon determining that the user needs to purchase the candidate product according to the estimation result, the analysis unit 250 determines the candidate product as a recommended product, and provides the product-related information received from the visible light illumination apparatus 100 to the user as recommended product information.

Upon determining, based on the product-related information and the user's purchase history information, that the user has purchased the candidate product at least a predetermined number of times at the current point in time after at least a predetermined period elapsed since the candidate product was last purchased, the analysis unit 250 determines the candidate product as a recommended product for the user. Here, the predetermined period is based on the purchase history information of the candidate product, more specifically, the average value of the purchase cycles of the candidate product calculated based on the previous purchase dates of the candidate product.

Even before the predetermined period of time has elapsed since the last purchase of the candidate product, the analysis unit 250 may determine the candidate product as a recommended product if user demand for the candidate product is persistent, and the current price of the candidate product has decreased by at least a predetermined threshold or more from the price at the last time when the user purchased the candidate product.

Even when the number of times of purchase of the candidate product is less than a predetermined number of times, the analysis unit 250 may determine the candidate product as a recommended product for the user if the candidate product was purchased within a preset period before the current point in time. Here, the preset period may be set to different values depending on the category of the candidate product and user selection.

The storage unit 240 according to some embodiments may store the user's family member information in addition to the user's purchase history information. The analysis unit 250 may infer the degree of consumption of the previously purchased recommended product at the current point in time based on the number of family members, the purchase cycle of the recommended product, and the time between the last purchase of the recommended product and the current time, and it may additionally calculate and provide a recommended purchase quantity of the recommended product according to the result of inference.

When the current price of the determined recommended product has increased from the product price at the last purchase of the recommended product by at least a predetermined threshold, the analysis unit 250 may additionally provide price change information and information on an alternative product for replacing the recommended product. The analysis unit 250 preferably provides a product in the same category as the recommended product as the alternative product among the products previously purchased by the user, based on the pre-stored purchase history information of the user, but embodiments are not limited thereto.

Upon receiving the user's purchase selection information of the recommended product, the analysis unit 250 does not determine another product in the same category as the recommended product, as a recommended product, in order to ensure efficiency of the product recommendation service.

Meanwhile, the storage unit 240 according to some embodiments may store further purchase history information of the user's family members. Thus, in another embodiment, the analysis unit 250 may identify a product to which the user's family members have a high preference among other products in the same category as the recommended product selected by the user, based on the purchase history information of the family members, and determine the product as a recommended product.

Upon receiving the user's purchase selection information of the recommended product from the user, the analysis unit 250 may receive additional discount information from the information provision apparatus 120 corresponding to the purchase decision of the recommended product, and further provide the same purchase selection information to the user.

The output unit 260 adaptively provides the product-related information of the recommended product determined by the analysis unit 250 to a user interface (UI) pre-configured in the display unit 220.

The collection unit 270 collects product-related information of the products pending purchase and loaded in the shopping cart 132. The collection unit 270 includes a means for collecting the product-related information such as, for example, a barcode scanner and a camera, and collects the product-related information of the products pending purchase and loaded in the shopping cart 132 by using the means.

The payment processing unit 280 calculates the total purchase price information of the products which the user has decided to purchase and provides the information to the product payment apparatus 130 in the store.

Upon receiving purchase confirmation information of at least one product pending purchase among those pending purchase from the user by using the user interface unit 230, the payment processing unit 280 calculates the total purchase price information of the at least one product pending purchase based on the product-related information of the products pending purchase. Then, the payment processing unit 280 provides the calculated total purchase price information to the product payment apparatus 130 in the store using the communication unit 210.

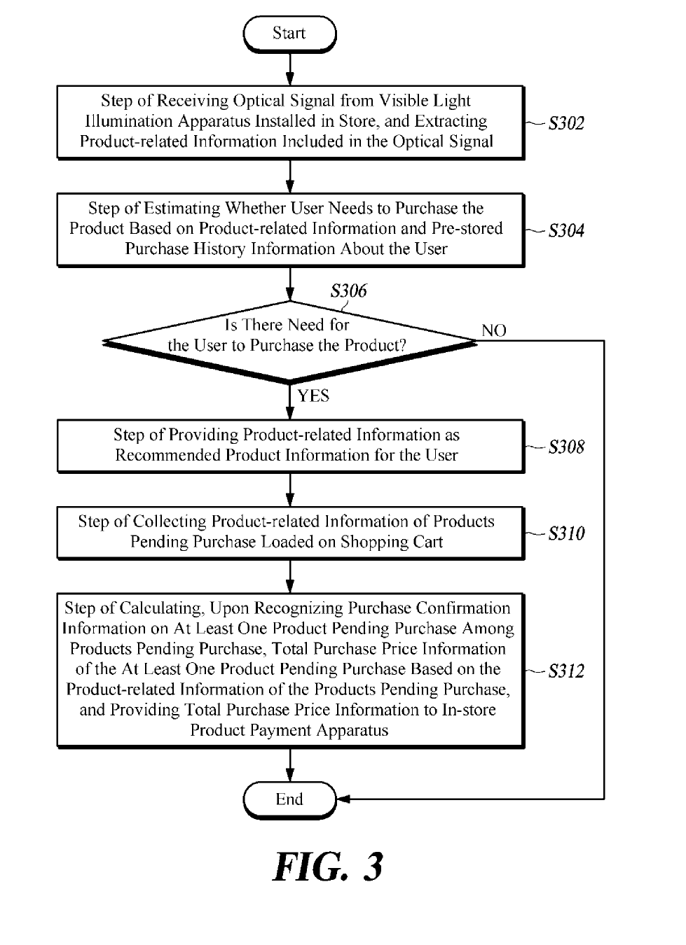

FIG. 3 is a flowchart illustrating a method of recommending a product to be purchased to a user in a store by using visible light communication by a product recommendation apparatus according to some embodiments.

According to some embodiments, the method of recommending a product to be purchased to a user in a store using visible light communication by the product recommendation apparatus 110 begins with the step of the product recommendation apparatus 110 receiving an optical signal from the visible light illumination apparatus 100 installed in the store and extracting product-related information included in the optical signal (S302). The product-related information extracted in Step S302 includes information such as the category, name, price and discount of a product.

The product recommendation apparatus 110 estimates whether the user needs to purchase a candidate product, based on the product-related information extracted in Step S302 and the user's purchase history information (S304). In Step S304, upon determining based on the product-related information and the user's purchase history information that the user has purchased the candidate product at least a predetermined number of times at the current point in time after at least a predetermined period elapsed since the candidate product was last purchased, the product recommendation apparatus 110 determines that the user needs to purchase the candidate product. In Step S304, the product recommendation apparatus 110 may perform all the operations in the same manner as performed in the aforementioned procedure of estimating, by the analysis unit 250 of the product recommendation apparatus 110, whether the user needs to purchase the candidate product and calculating the candidate product as a recommended product.

Upon determining that the user needs to purchase the candidate product according to the estimation result obtained in Step S304 (S306), the product recommendation apparatus 110 determines the candidate product as a recommended product, and provides the product-related information received in Step S302 as recommended product information for the user (S308).

The product recommendation apparatus 110 collects product-related information of the products pending purchase and loaded on the shopping cart 132 (S310). In Step S310, the product recommendation apparatus 110 collects the product-related information of the products pending purchase and loaded in the shopping cart 132, by using a barcode scanner, a camera, or the like.

Upon receiving purchase confirmation information of at least one product pending purchase among those pending purchase, the product recommendation apparatus 110 calculates the total purchase price information of the at least one product pending purchase based on the product-related information of the products pending purchase collected in Step S310, and provides the calculated total purchase price information to the product payment apparatus 130 (S312).

Since Steps S302 to S312 correspond to the operations of the communication unit 210, the analysis unit 250, the collection unit 270, and the payment processing unit 280 of the purchase route guide apparatus 110 described above, further detailed description thereof will be omitted.

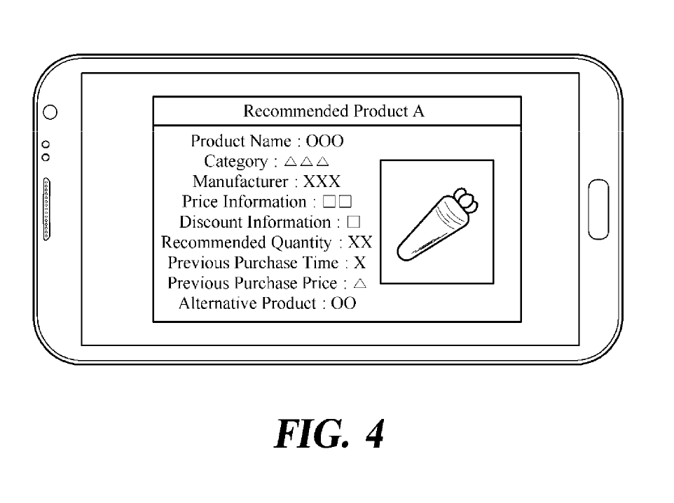

FIG. 4 is an exemplary diagram illustrating a method of providing recommended product information by a product recommendation apparatus according to some embodiments.

As shown in FIG. 4, the product recommendation apparatus 110 according to some embodiments adaptively provides the product-related information of the product determined as the recommended product to a pre-configured UI, for example, an information provision window for the recommended product. Here, the information provision window for the recommended product includes information such as a photograph, product name, category, manufacturer, price, and discount of the recommended product.

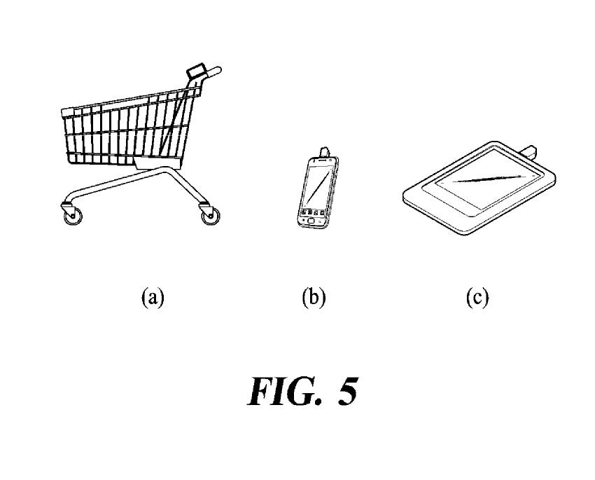

FIG. 5 is an exemplary diagram illustrating embodiments of a product recommendation apparatus according to some embodiments.

As shown in FIG. 5 (a-c), the product recommendation apparatus 110 according to some embodiments may be implemented by being attached to a terminal or a tablet of the user, a cart used by the user in purchasing products, and the like. The embodiments of the product recommendation apparatus 110 are not limited thereto, and the product recommendation apparatus 110 may be attached to any belongings of the user which the user may carry during purchase of products. While FIG. 5 (a-c) illustrates that the product recommendation apparatus 110 is implemented as an apparatus separate from the user's belongings, embodiments are not limited thereto. The product recommendation apparatus 110 may be implemented as a component of the user's belongings.

Although exemplary embodiments of the present disclosure have been described for illustrative purposes, those skilled in the art will appreciate that various modifications, additions and substitutions are possible, without departing from the spirit and scope of the appended claims. Therefore, the present disclosure is to be construed as illustrative rather than limiting, and the scope of the present disclosure is not limited by the illustrative embodiments. The scope of protection of the disclosure should be construed according to the appended claims, and all technical ideas within the scope of the claims and equivalents thereof should be construed as being within the scope of the disclosure.

### CROSS-REFERENCE TO RELATED APPLICATION

This application claims priority, under 35 U.S.C. § 119(a), to Patent Application No. 10-2015-0056162, filed on Apr. 21, 2015 in Korea, the entire contents of which are incorporated herein by reference. In addition, this non-provisional application claims priority in countries, other than the U.S., with the same reason based on the Korean patent application, the entire contents of which are hereby incorporated herein by reference.

1. A product recommendation apparatus for providing information on a product to a user in a store by using visible light communications, the apparatus comprising:
a communication unit configured to receive an optical signal from a visible light illumination apparatus installed in the store and to extract a product-related information included in the optical signal;
a storage unit configured to store a purchase history information of the user; and
an analysis unit configured to perform an estimation of whether the user needs to purchase the product based on the product-related information and the purchase history information and to provide the product-related information as a recommended product information for the user according to a result of the estimation.

2. The product recommendation apparatus according to claim 1, further comprising:
a collection unit configured to collect a product-related information of products pending purchase and loaded into a shopping cart; and
a payment processing unit configured to calculate, upon receiving a purchase confirmation information of at least one product pending purchase among the products pending purchase, a total purchase price information of the at least one product pending purchase based on the product-related information of the products pending purchase and to provide the total purchase price information to a product payment apparatus in the store.

3. The product recommendation apparatus according to claim 1, wherein the product-related information comprises some or all of a category, a name, a price information and a discount information of the product.

4. The product recommendation apparatus according to claim 1, wherein the purchase history information comprises a purchased product information, a total number of purchases of the purchased product, a purchase date of the purchased product, a price information at the time of purchase of the purchased product, and a discount information at the time of purchase of the purchased product.

5. The product recommendation apparatus according to claim 1, wherein, upon determining that the user has purchased the product at least a predetermined number of times at a current point in time after at least a predetermined period elapsed since a last purchase of the product, the analysis unit determines the product as a recommended product for the user.

6. The product recommendation apparatus according to claim 5, wherein the predetermined period is determined based on an average value of purchase cycles of the product.

7. The product recommendation apparatus according to claim 5, wherein, when a period between the last purchase of the product and the current point in time is shorter than the predetermined period and a current price of the product has decreased from a price at the last purchase of the product by at least a predetermined threshold, the analysis unit selectively determines the product as the recommended product for the user.

8. The product recommendation apparatus according to claim 5, wherein, when the number of times of purchase of the product is less than a predetermined number of times, and the product was purchased within a preset period before the current point in time, the analysis unit selectively determines the product as the recommended product.

9. The product recommendation apparatus according to claim 1, wherein the storage unit further stores a user information including a family member information of the user,
wherein the analysis unit calculates a recommended purchase quantity of the recommended product based on the family member information and a time between the last purchase of the recommended product and the current point in time, and provides the recommended purchase quantity together with the product-related information.

10. The product recommendation apparatus according to claim 1, wherein, when a current price of the recommended product has increased from a product price at the last purchase of the recommended product by at least a predetermined threshold, the analysis unit further provides a price change information and information on an alternative product to replace the recommended product.

11. The product recommendation apparatus according to claim 10, wherein the analysis unit provides a product in the same category as the recommended product as the alternative product among products previously purchased by the user, based on the purchase history information.

12. The product recommendation apparatus according to claim 1, wherein, upon receiving purchase selection information of the recommended product for the user, the analysis unit receives an additional discount information from an information provision apparatus in the store corresponding to a purchase decision of the recommended product, and additionally provides the additional discount information to the user.

13. The product recommendation apparatus according to claim 1, wherein, upon receiving a purchase selection information of the recommended product for the user, the analysis unit does not determine another product in the same category as the recommended product as a recommended product.

14. The product recommendation apparatus according to claim 13, wherein the storage unit stores further user information including information on family members of the user and a purchase history information of the family members, and
wherein the analysis unit selectively determines the another product as the recommended product based on the purchase history information of the family members.

15. The product recommendation apparatus according to claim 14, wherein the storage unit classifies products included in the purchase history information of the family members into public products and private products according to categories of the products, stores classified products, and selectively provides only purchase history information corresponding to the public products in the purchase history information of the family members according to a result of classifying the products as a parameter for selectively determining the another product as the recommended product.

16. A method of providing information on a product to a user in a store by a product recommendation apparatus using visible light communications, the method comprising:
receiving an optical signal from a visible light illumination apparatus installed in the store and extracting a product-related information included in the optical signal; and
performing an estimation of whether the user needs to purchase the product based on the product-related information and a pre-stored user's purchase history information and providing the product-related information as recommended product information for the user according to a result of the estimation.
